(19) United States
(12) Patent Application Publication
(10) Pub. No.: US 2004/0144030 A1
(43) Pub. Date: Jul. 29, 2004

(54) Torch ignited partial oxidation fuel reformer and method of operating the same

(76) Inventor: Rudolf M. Smaling, Bedford, MA (US)

Correspondence Address: BARNES & THORNBURG, 11 SOUTH MERIDIAN, INDIANAPOLIS, IN, 46204

(21) Appl. No.: 10/349,654

(22) Filed: Jan. 23, 2003

(51) Int. Cl. C10J 1/00; B01J 8/00

(52) U.S. Cl. 48/211; 48/127.9; 48/62 R; 48/107; 48/95; 48/198.1; 48/215; 48/197 R

(57) ABSTRACT

A partial oxidation fuel reformer in includes a torch assembly for generating a near-stoichiometric flame through which a relatively rich “primary” air/fuel mixture is advanced. The torch assembly includes a low-energy ignition source such as a conventional sparkplug. The flame has sufficient energy to ignite the primary mixture to facilitate a partial oxidation reaction. A method of operating a partial oxidation fuel reformer is also disclosed.

### FIELD OF THE DISCLOSURE

The present disclosure relates generally to partial oxidation fuel reformers, and more particularly to onboard partial oxidation fuel reformers for reforming fuel onboard a vehicle or stationary power generator.

### BACKGROUND OF THE DISCLOSURE

Partial oxidation fuel reformers reform hydrocarbon fuel into a reformate gas such as hydrogen-rich gas. In the case of an onboard partial oxidation fuel reformer of a vehicle or stationary power generator, the reformate gas produced by the reformer may be utilized as fuel or fuel additive in the operation of an internal combustion engine. The reformate gas may also be utilized to regenerate or otherwise condition an emission abatement device associated with the internal combustion engine or as a fuel for a fuel cell.

### SUMMARY OF THE DISCLOSURE

According to one aspect of the present disclosure, there is provided a partial oxidation fuel reformer in which a rich fuel is ignited by a torch. The torch is generated by use of a near-stoichiometric flame which is ignited by a low-energy ignition source such as a conventional sparkplug.

To do so, a relatively small portion of the fuel being processed by the fuel reformer (e.g., ˜10% or less) is mixed with air in a near-stoichiometric ratio and thereafter injected into the fuel reformer and ignited by the sparkplug. The resulting flame has sufficient energy to ignite the relatively rich “primary” air/fuel mixture (e.g., a mixture having an oxygen-to-carbon ratio of approximately 1.0:1) to complete a partial oxidation reaction of both mixtures.

The reformate gas produced by the reformer may be utilized as fuel or fuel additive in the operation of an internal combustion engine. The reformate gas may also be utilized to regenerate or otherwise condition an emission abatement device associated with an internal combustion engine or as a fuel for a fuel cell.

In accordance with another aspect of the present disclosure, there is provided a method of operating a partial oxidation fuel reformer. The method includes igniting a near-stoichiometric air/fuel mixture to create a flame. A rich air/fuel mixture is ignited by the flame and reformed into a reformate gas.

A sparkplug may be used to ignite the near-stoichiometric air/fuel mixture. Alternatively, a glow plug may be used to ignite the near-stoichiometric air/fuel mixture.

Once ignited, the flame may be sustained by the continuous introduction of additional amounts of the near-stoichiometric air/fuel mixture without the use of an ignition device (e.g., without the use of the sparkplug or glow plug).

### BRIEF DESCRIPTION OF THE DRAWINGS

FIG. 1 is a simplified block diagram of a fuel reforming assembly having a partial oxidation fuel reformer under the control of an electronic control unit;

FIG. 2 is a diagrammatic cross sectional view of the partial oxidation fuel reformer of FIG. 1; and

FIG. 3 is a flowchart of a control procedure executed by the control unit during operation of the fuel reforming assembly of FIG. 1.

### DETAILED DESCRIPTION OF ILLUSTRATIVE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

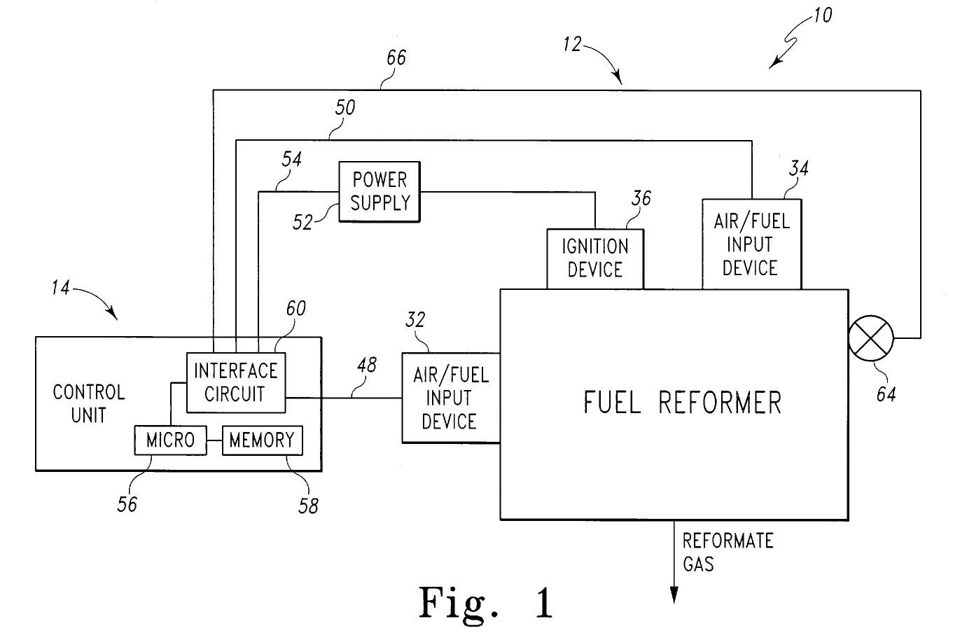

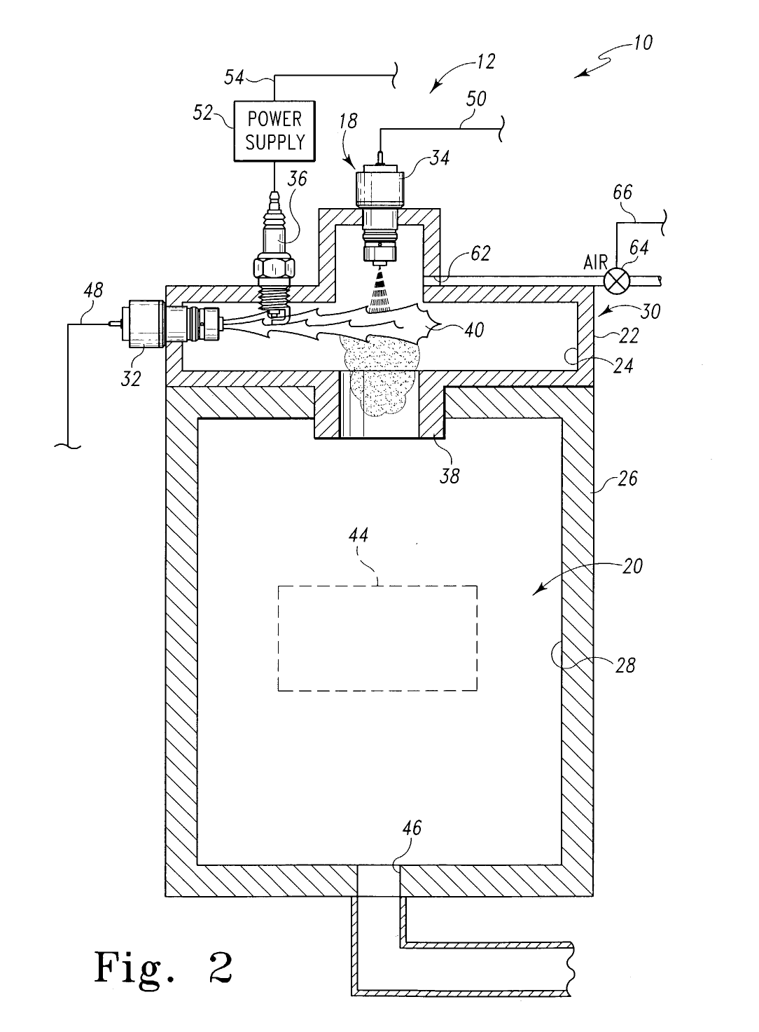

Referring now to FIGS. 1 and 2, there is shown a fuel reforming assembly 10 having a partial oxidation fuel reformer 12 and a control unit 14. The partial oxidation fuel reformer 12 reforms (i.e., converts) hydrocarbon fuels into a reformate gas that includes, amongst other things, hydrogen and carbon monoxide. As such, the partial oxidation fuel reformer 12, amongst other uses, may be used in the construction of an onboard fuel reforming system of a vehicle or stationary power generator. In such a way, the reformats gas produced by the partial oxidation fuel reformer 12 may be utilized as fuel or fuel additive in the operation of an internal combustion engine thereby increasing the efficiency of the engine while also reducing emissions produced by the engine. The reformate gas from the partial oxidation fuel reformer 12 may also be utilized to regenerate or otherwise condition an emission abatement device associated with an internal combustion engine. In addition, if the vehicle or the stationary power generator is equipped with a fuel cell such as, for example, an auxiliary power unit (APU), the reformate gas from the partial oxidation fuel reformer 12 may also be used as a fuel for the fuel cell.

As shown in FIG. 2, the partial oxidation fuel reformer 12 includes a ignition assembly 18 and a reactor 20. The fuel reformer 12 also includes a housing 30. The housing 30 may be embodied as a single, unitary structure, or, alternatively, as shown in FIG. 2, the housing 30 may be embodied as a number of discrete structures such as an ignition housing 22 having an ignition chamber 24 defined therein and a reactor housing 26 having a reaction chamber 28 defined therein.

The ignition assembly 18 is secured to an upper portion of the reactor housing 26. The ignition assembly 18 includes a pair of fuel input mechanisms 32, 34. In the exemplary embodiment of FIG. 2, the fuel input mechanisms 32, 34 are embodied as conventional automotive fuel injectors which inject hydrocarbon fuel, typically in the form of a mixture with air, into the ignition chamber 24. As such, the fuel injectors 32, 34 may be embodied as any type of fuel injection mechanism which injects a desired amount of an air/fuel mixture into the ignition chamber 24. In certain configurations, it may be desirable to atomize the fuel prior to, or during, injection of the air/fuel mixture into the ignition chamber 24. Such fuel injector assemblies (i.e., injectors which atomize the fuel) are commercially available.

Pressurized air is advanced into the ignition chamber 24 through an air inlet 62 and is thereafter mixed with the fuel (or an atomized mixture of air and fuel) injected by the fuel injector 34. As such, a desired mixture of air and fuel (“air/fuel mixture”) may be generated via control of the fuel injector 34 and an air inlet valve 64. The air inlet valve 64 may be embodied as any type of electronically-controlled air valve. The air inlet valve 64 may be embodied as a discrete device, as shown in FIG. 2, or may be integrated into the design of the partial oxidation fuel reformer 12. In either case, the air inlet valve 64 controls the amount of air that is introduced into the ignition chamber 24 thereby controlling the air-to-fuel ratio of the air/fuel mixture being processed by the fuel reformer 12.

Operation of the fuel injectors 32, 34 and the air inlet valve 64 allow for the generation of different air/fuel mixtures in the ignition chamber 24. In particular, as alluded to above, the fuel reformer 12 reforms or otherwise processes hydrocarbon fuel in the form of a relatively rich mixture of air and fuel. Such a rich air/fuel mixture may be generated by control of the separate air/fuel mixtures created by the fuel injectors 32, 34 and the air inlet valve 64. In particular, a very rich “primary” air/fuel mixture is generated by the fuel injector 34 and the air inlet valve 64, whereas a much leaner “ignition” air/fuel mixture is generated by the fuel injector 32. These two mixtures collectively define the “overall” air/fuel mixture being processed by the partial oxidation reformer 12.

The air-to-fuel ratio of the overall mixture being processed by the fuel reformer 12 may be controlled to maintain the oxygen-to-carbon ratio of the mixture within a desired range. In the exemplary embodiment described herein, the oxygen-to-carbon ratio is maintained in the range of about 1.05:1-1.25:1. In regard to the reforming of gasoline or diesel fuel, such the oxygen-to-carbon ratio is maintained in such an exemplary range (i.e., 1.05-1.25) by maintaining the air-to-fuel ratio in the range of 5.25:1-6.25:1. As described herein in greater detail, by controlling operation of the fuel injectors 32, 34 and the air inlet valve 64, the overall air/fuel mixture being processed by the fuel reformer 12 may be controlled within this, or any other, such air-to-fuel ratio range.

As alluded to above, the fuel injector 34 and the air inlet valve 64 are operated to generate the relatively rich primary air/fuel mixture. In particular, fuel injected by the fuel injector 34 is mixed with air introduced through the air inlet valve 64 to create the rich air/fuel mixture. As such, the amount of fuel injected by the fuel injector 34 and/or the amount air introduced by the air inlet valve 64 may be varied to vary the resultant air/fuel mixture. Moreover, if the fuel injector 34 is embodied as an air-assisted fuel injector which atomizes the fuel during injection thereof, the amount of air introduced through the air inlet valve 64 may be controlled to account for the air introduced by the injector 34. In any case, it should be appreciated that control routines may be implemented which allow for control of the fuel injector 34 and the air inlet valve 64 to produce a desired primary mixture. In the exemplary embodiment described herein, the primary mixture may be controlled to produce an mixture having an oxygen-to-carbon ratio in the range of 0.8:1-1.4:1, and in a more specific example, an oxygen-to-carbon ratio in the range of 0.8:1-1.1:1. In regard to the reforming of gasoline or diesel fuel, the oxygen-to-carbon ratio may be maintained in such exemplary ranges (i.e., 0.8:1-1.4:1 and 0.8:1-1.1:1) by maintaining the air-to-fuel ratio in the range of 4.0:1-7.0:1 and 4.0:1-5.5:1, respectively.

The fuel injector 32 is utilized to produce the much leaner ignition mixture. In particular, the ignition mixture may be embodied in the form of a near-stoichiometric air/fuel mixture. As used herein, the term “near-stoichiometric” refers to an air-to-fuel mixture which is near the stoichiometric ratio of the particular fuel being used. For example, in regard to diesel fuel or gasoline, a near-stoichiometric air-to-fuel ratio may include air-to-fuel ratios within the range of about 10:1-15:1. To produce such a near-stoichiometric mixture, the fuel injector 32 may be embodied as a fixed-orifice, air-assisted fuel injector which atomizes the fuel with a fixed amount of air during injection of the fuel into the ignition chamber 24. Such a fixed amount of air may be predetermined to produce an air-to-fuel ratio within the desired near-stoichiometric range (i.e., within the range of about 10:1-15:1).

The fuel being injected by the fuel injectors 32, 34 may be any type of hydrocarbon fuel including different hydrocarbon fuels. In particular, it is contemplated that the fuel injector 32 may inject a fuel which is different than the primary fuel being injected by the fuel injector 34. However, in the case of an onboard partial oxidation fuel reformer, it is generally desirable to utilize the same fuel to eliminate the need to store multiple fuel types on the vehicle or generator. In such a case, both injectors would utilize the same type of fuel (e.g., gasoline or diesel fuel), but would generate different air/fuel mixtures as described above.

The ignition source 36 is embodied as a low-energy ignition device. In particular, as used herein, the term “low-energy” refers to devices having energy requirements in the range of 0.1 mJ-24 mJ. As such, the term “low-energy” as used herein is distinct from the relatively high-energy ignition sources of other types of fuel reformers such as plasma reformers (which utilize a relatively high-energy plasma arc) and thermal reformers (which utilize a relatively high-energy heat source). In the exemplary embodiment described herein, the low-energy ignition device is embodied as a conventional sparkplug. However, other types of energy devices are also contemplated such as mechanical spark generators and glow plugs.

Although shown in FIG. 2 as generating a flame which is substantially perpendicular to the direction in which the fuel injector 34 injects fuel, it should be appreciated that other configurations of the ignition assembly 18 are contemplated. For example, the ignition assembly 18 may be configured such that the flame 40 is inline with (i.e., coaxially arranged with) the injected fuel from the fuel injector 34.

Referring back to FIG. 2, an outlet 38 of the ignition housing 22 extends downwardly into the reactor housing 26. As such, gas (either reformed or partially reformed) exiting the flame 40 is advanced into the reaction chamber 28. A catalyst 44 is positioned in the reaction chamber 28. The catalyst 44 completes the fuel reforming process, or otherwise treats the gas, prior to exit of the reformate gas through a gas outlet 46. In particular, some or all of the gas exiting the ignition assembly 18 may only be partially reformed, and the catalyst 44 is configured to complete the reforming process (i.e., catalyze a reaction which completes the reforming process of the partially reformed gas exiting the ignition assembly 18). The catalyst 44 may be embodied as any type of catalyst that is configured to catalyze such reactions. In one exemplary embodiment, the catalyst 44 is embodied as a substrate having a precious metal or other type of catalytic material disposed thereon. Such a substrate may be constructed of ceramic, metal, or other suitable material. The catalytic material may be, for example, embodied as platinum, rhodium, palladium, including combinations thereof, along with any other similar catalytic materials.

As shown in FIG. 1, the partial oxidation fuel reformer 12 and its associated components are under the control of the control unit 14. In particular, the fuel injector 32 is electrically coupled to the electronic control unit 14 via a signal line 48, the fuel injector 34 is electrically coupled to the electronic control unit 14 via a signal line 50, the power supply 52 associated with the sparkplug 36 is electrically coupled to the electronic control unit 14 via a signal line 54, and the air inlet valve 64 is electrically coupled to the electronic control unit 16 via a signal line 66. Although the signal lines 48, 50, 54, 66 are shown schematically as a single line, it should be appreciated that the signal lines may be configured as any type of signal carrying assembly which allows for the transmission of electrical signals in either one or both directions between the electronic control unit 14 and the corresponding component. For example, any one or more of the signal lines 48, 50, 54, 66 may be embodied as a wiring harness having a number of signal lines which transmit electrical signals between the electronic control unit 14 and the corresponding component. It should be appreciated that any number of other wiring configurations may also be used. For example, individual signal wires may be used, or a system utilizing a signal multiplexer may be used for the design of any one or more of the signal lines 48, 50, 54, 66. Moreover, the signal lines 48, 50, 54, 66 may be integrated such that a single harness or system is utilized to electrically couple some or all of the components associated with the partial oxidation fuel reformer 12 to the electronic control unit 14.

The electronic control unit 14 is, in essence, the master computer responsible for interpreting electrical signals sent by sensors associated with the partial oxidation fuel reformer 12 (if any sensors are used) and for activating electronically-controlled components associated with the partial oxidation fuel reformer 12 in order to control the partial oxidation fuel reformer 12. For example, the electronic control unit 14 of the present disclosure is operable to, amongst many other things, determine the beginning and end of each injection cycle of the fuel injectors 32, 34, calculate and control the amount and ratio of air and fuel to be introduced into the ignition chamber 24 by the fuel injectors 32, 34 and the air inlet valve 64, determine when or if to spark the sparkplug 36, etcetera.

To do so, the electronic control unit 14 includes a number of electronic components commonly associated with electronic units which are utilized in the control of electromechanical systems. For example, the electronic control unit 14 may include, amongst other components customarily included in such devices, a processor such as a microprocessor 56 and a memory device 58 such as a programmable read-only memory device (“PROM”) including erasable PROM's (EPROM's or EEPROM's). The memory device 58 is provided to store, amongst other things, instructions in the form of, for example, a software routine (or routines) which, when executed by the processing unit, allows the electronic control unit 14 to control operation of the partial oxidation fuel reformer 12.

The electronic control unit 14 also includes an analog interface circuit 60. The analog interface circuit 60 converts the output signals from various fuel reformer sensors (if any are used) into a signal which is suitable for presentation to an input of the microprocessor 56. In particular, the analog interface circuit 60, by use of an analog-to-digital (A/D) converter (not shown) or the like, converts the analog signals generated by the sensors into a digital signal for use by the microprocessor 56. It should be appreciated that the A/D converter may be embodied as a discrete device or number of devices, or may be integrated into the microprocessor 56. It should also be appreciated that if any one or more of the sensors associated with the partial oxidation fuel reformer 12 generate a digital output signal, the analog interface circuit 60 may be bypassed.

Similarly, the analog interface circuit 60 converts signals from the microprocessor 56 into an output signal which is suitable for presentation to the electrically-controlled components associated with the partial oxidation fuel reformer 12 (e.g., the fuel injectors 32, 34, the power supply 52 associated with the sparkplug 36, or the air inlet valve 64). In particular, the analog interface circuit 60, by use of a digital-to-analog (D/A) converter (not shown) or the like, converts the digital signals generated by the microprocessor 56 into analog signals for use by the electronically-controlled components associated with the fuel reformer 12 such as the fuel injectors 32, 34, the power supply 52 associated with the sparkplug 36, or the air inlet valve 64. It should be appreciated that, similar to the A/D converter described above, the D/A converter may be embodied as a discrete device or number of devices, or may be integrated into the microprocessor 56. It should also be appreciated that if any one or more of the electronically-controlled components associated with the partial oxidation fuel reformer 12 operate on a digital input signal, the analog interface circuit 60 may be bypassed.

Hence, the electronic control unit 14 may be operated to control operation of the partial oxidation fuel reformer 12. In particular, the electronic control unit 14 executes a routine including, amongst other things, a closed-loop control scheme in which the electronic control unit 14 monitors outputs of any sensors associated with the partial oxidation fuel reformer 12 in order to control the inputs to the electronically-controlled components associated therewith. To do so, the electronic control unit 14 communicates with the sensors associated with the fuel reformer which may be used to determine, amongst numerous other things, the amount, temperature, and/or pressure of air and/or fuel being supplied to the partial oxidation fuel reformer 12, the amount of oxygen in the reformate gas, the temperature of the reformate gas, the composition of the reformate gas, etcetera. Armed with this data, the electronic control unit 14 performs numerous calculations each second, including looking up values in preprogrammed tables, in order to execute algorithms to perform such functions as determining when or how long the fuel reformer's fuel injectors are opened, controlling the spark generation of the sparkplug, controlling operation of the air inlet valve 64 to control the amount of air being introduced into the ignition chamber 24, etcetera.

In an exemplary embodiment, the aforedescribed control scheme includes a routine for reforming a relatively rich primary air/fuel mixture into a reformate gas containing, amongst other things, hydrogen and carbon monoxide by the use of a torch. In particular, unlike other types of fuel reformers which utilize a relatively high electrical energy source to “crack” the hydrocarbon fuel into smaller components (e.g., hydrogen and carbon monoxide), the partial oxidation fuel reformer 12 of the present disclosure utilizes a relatively low-energy electrical source to do so. Specifically, the relatively rich primary air/fuel mixture is ignited during the reforming process by energy provided by a flame. The flame is generated by the ignition of an air/fuel mixture which is significantly leaner than the relatively rich primary air/fuel mixture. As a result, the overall air/fuel mixture being processed by the fuel reformer 12 (i.e., the combination of both the ignition mixture and the primary mixture) is reformed into a reformate gas which is rich in, amongst other gases, hydrogen and carbon monoxide.

One specific exemplary way to do so is by utilizing the fuel injectors 32, 34 to inject air/fuel mixtures of differing air-to-fuel ratios with the leaner of the two mixtures being ignited by the sparkplug 36 to generate a flame through which the richer of the two mixtures is advanced. More specifically, a near-stoichiometric air/fuel mixture is injected into the ignition chamber 24 by the fuel injector 32 and thereafter ignited by the sparkplug 36 thereby creating the flame 40. Once the flame 40 is ignited, continued injection of the near-stoichiometric air/fuel mixture will sustain the flame 40 without use of the sparkplug 36. The fuel injector 34 and the air inlet valve 64 are then operated to generate a relatively rich air/fuel mixture (e.g., with an oxygen-to-carbon ratio in the range of, for example, 0.8:1-1.4:1) into contact with the flame 40. The flame 40 has sufficient energy to ignite the rich air/fuel mixture from the fuel injector 34 thereby facilitating partial oxidation of the overall air/fuel mixture. As described above, the gas exiting the flame 40 is then directed into the reactor 20 where the partial oxidation reaction may be furthered by either the energy present in the reactor 20 in the form of heat and/or by use of the catalyst 44.

It should be appreciated that the air-to-fuel ratio of the relatively rich primary air/fuel mixture being introduced by the fuel injector 34 may be altered during operation of the fuel reformer 12. In particular, during operation of the fuel reformer 12, the composition, temperature, or quantity of the reformate gas being produced by the reformer 12 may be altered by altering the air-to-fuel ratio of the relatively rich primary fuel. As described above, such altering of the air-to-fuel ratio may be accomplished by adjusting the amount of fuel injected by the fuel injector 34 and/or the amount of air introduced by the air inlet valve 64. The magnitude of the flame 40 may likewise be altered to correspond with such changes in the primary fuel. Closed-loop control for such changes in air-to-fuel ratio of the primary fuel may be established by the use of one or more sensors such as composition sensors, oxygen sensors, temperature sensors, or the like.

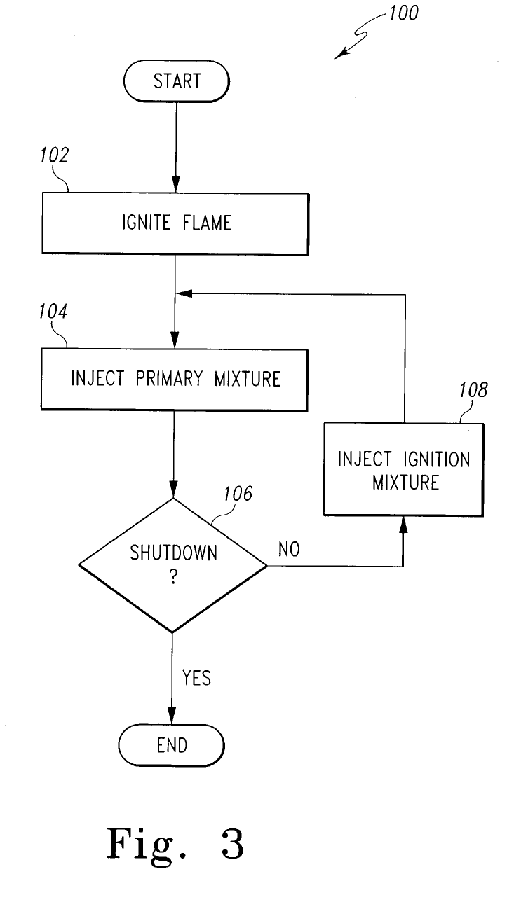

Referring now to FIG. 3, there is shown a control routine 100 for controlling operation of the partial oxidation fuel reformer 12. The control routine 100 begins with step 102 in which the control unit 14 ignites the flame 40. In particular, the control unit 14 generates an output signal on the signal line 48 and the signal line 54 thereby igniting the flame 40. More specifically, the control unit 14 operates the fuel injector 32 to inject a quantity of a near-stoichiometric air/fuel mixture into the ignition chamber and thereafter ignites the mixture with the spark plug 36 thereby initiating the flame 40. The routine 100 then advances to step 104.

In step 104, the control unit 14 introduces the a relatively rich air/fuel mixture into the fuel reformer 12. In particular, the control unit 14 generates an output signal on the signal lines 50 and 64 thereby operating the fuel injector 34 and the air inlet valve 64 to generate a quantity of the relatively rich air/fuel mixture which is advanced into contact with the flame 40. As such, partial oxidation of the overall air/fuel mixture being processed by the fuel reformer 12 commences and the resultant reformate gas (or partially reformed gas) is advanced into the reactor 20 and thereafter out of the fuel reformer 12. The routine 100 then advances to step 106.

In step 106, the control unit 14 determines if the fuel reformer 12 is to continue operation. In particular, the control unit 14 determines if a shutdown request has been received, and, if so, ends the routine 100 thereby ceasing operation of the fuel reformer 12. If a shutdown request has not been received, the control routine 100 advances to step 108.

In step 108, the control unit 14 maintains generation of the flame 40. In particular, the control unit 14 generates output signals on the signal line 48 so as to continue the injection of the near-stoichiometric air/fuel mixture into the ignition chamber 24 by the fuel injector 32. Note that in step 108 the control unit 14 may not need to operate the sparkplug 36 since, once ignited, the flame 40 is “self-sustaining” by the continued introduction of fuel. The control routine 106 then advances to step 104 to continue introduction of the primary air/fuel mixture.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of operating a partial oxidation fuel reformer, the method comprising the steps of:
igniting a first air/fuel mixture having a first air-to-fuel ratio so as to create a flame, and
advancing a second air/fuel mixture having a second air-to-fuel ratio into contact with the flame so as to generate reformate gas.

2. The method of claim 1, wherein the first air-to-fuel ratio is greater than the second air-to-fuel ratio.

3. The method of claim 1, wherein the first air-to-fuel ratio comprises a near-stoichiometric air-to-fuel ratio.

4. The method of claim 1, wherein the first air/fuel mixture has an air-to-fuel ratio in the range of about 10:1-15:1.

5. The method of claim 1, wherein the second air/fuel mixture has an oxygen-to-carbon ratio in the range of 0.8:1-1.4:1.

6. The method of claim 1, wherein the second air/fuel mixture has an oxygen-to-carbon ratio in the range of 0.8:1-1.1:1.

7. The method of claim 1, wherein the igniting step comprises igniting the first air/fuel mixture with a sparkplug.

8. The method of claim 1, wherein the igniting step comprises:
injecting the first air/fuel mixture into a chamber,
igniting the first air/fuel mixture with a sparkplug so as to initiate the flame in the chamber, and
sustaining the flame by continued injection of the first air/fuel mixture into the chamber.

9. The method of claim 1, wherein the advancing step comprises partially oxidizing both the first air/fuel mixture and the second air/fuel mixture so as to generate the reformate gas.

10. A partial oxidation fuel reformer, comprising:
a housing having a ignition chamber,
a first fuel input device configured to input a first air/fuel mixture into the ignition chamber,
an ignition device configured to ignite the first air/fuel mixture, and
a second fuel input device configured to input a second air/fuel mixture into the ignition chamber.

11. The partial oxidation fuel reformer of claim 10, wherein the ignition device comprises a spark ignition device.

12. The partial oxidation fuel reformer of claim 11, wherein the spark ignition device comprises a sparkplug.

13. The partial oxidation fuel reformer of claim 10, wherein the ignition device comprises a glow plug.

14. The partial oxidation fuel reformer of claim 10, wherein:
the first fuel input device comprises a first fuel injector, and
the second fuel input device comprises a second fuel injector.

15. The partial oxidation fuel reformer of claim 10, further comprising a catalyst positioned in the housing.

16. The partial oxidation fuel reformer of claim 15, wherein:
the housing further has a reaction chamber positioned downstream from the ignition chamber, and
the catalyst is positioned in the reaction chamber.

17. The partial oxidation fuel reformer of claim 10, further comprising an air inlet valve configured to input air into the ignition chamber.

18. A fuel reforming assembly, comprising:
a partial oxidation fuel reformer having (i) a first fuel injector, (ii) a second fuel injector, and (iii) an ignition device, and
a controller electrically coupled to each of the first fuel injector, the second fuel injector, and the ignition device, the controller comprising (i) a processor, and (ii) a memory device electrically coupled to the processor, the memory device having stored therein a plurality of instructions which, when executed by the processor, causes the processor to:
operate the first fuel injector so as to inject a first air/fuel mixture having a first air-to-fuel ratio into the fuel reformer,
operate the ignition device to ignite the first air/fuel mixture so as to create a flame,
operate the second fuel injector so as to inject a second air/fuel mixture having a second air-to-fuel ratio into contact with the flame.

19. The fuel reforming assembly of claim 18, wherein the first air-to-fuel ratio is greater than the second air-to-fuel ratio.

20. The fuel reforming assembly of claim 18, wherein the first air-to-fuel ratio comprises a near-stoichiometric air-to-fuel ratio.

21. The fuel reforming assembly of claim 18, wherein the second air/fuel mixture has an oxygen-to-carbon ratio in the range of 0.8:1-1.4:1.

22. The fuel reforming assembly of claim 18, wherein the second air/fuel mixture has an oxygen-to-carbon ratio in the range of 0.8:1-1.1:1

23. The fuel reforming assembly of claim 18, wherein the ignition device comprises a sparkplug.

24. The fuel reforming assembly of claim 18, further comprising an air inlet valve electrically coupled to the controller, wherein the plurality of instructions, when executed by the processor, further cause the processor to operate the second fuel injector and the air inlet valve to generate the second air/fuel mixture.

25. A partial oxidation fuel reformer comprising:
a housing having an ignition chamber,
a first fuel injector configured to inject a near stoichiometric air/fuel mixture into the ignition chamber,
a sparkplug configured to ignite the first air/fuel mixture so as to create a flame in the ignition chamber, and
a second fuel injector configured to inject fuel into contact with the flame.

26. The partial oxidation fuel reformer of claim 25, further comprising an air inlet valve configured to introduce air into the fuel injected by the second fuel injector so as to generate an air/fuel mixture having an air-to-fuel ratio in the range of 4.0:1-7.0:1.

27. The partial oxidation fuel reformer of claim 25, further comprising a catalyst positioned in the housing.

28. The partial oxidation fuel reformer of claim 25, wherein:
the housing further has a reaction chamber positioned downstream from the ignition chamber, and
the catalyst is positioned in the reaction chamber.
